(19) United States
(12) Patent Application Publication
(10) Pub. No.: US 2023/0081256 A1
(43) Pub. Date: Mar. 16, 2023

(54) VIDEO DISPLAY SYSTEM AND VIDEO DISPLAY METHOD

(71) Applicant: NEC Corporation, Minato-ku, Tokyo (JP)

(72) Inventor: Teruyuki MOTOHASHI, Tokyo (JP)

(73) Assignee: NEC Corporation, Minato-ku, Tokyo (JP)

(21) Appl. No.: 17/908,030

(22) PCT Filed: Mar. 25, 2020
(86) PCT No.: PCT/JP2020/013372

§ 371 Date: Aug. 30, 2022

(51) Int. Cl. H04N 7/18; H04N 5/268

(52) U.S. Cl. CPC H04N 7/181; H04N 5/268; H04N 2005/2255

(57) ABSTRACT

A video display system according to the present disclosure includes a mask, an infrared camera disposed on the mask, a visible-light camera disposed on the mask, first communication means disposed on an outfit, and a leader terminal, in which: the leader terminal includes second communication means, display means, and selecting means for selecting one of an infrared camera image and a visible-light camera image as an image to be displayed; the second communication means transmits an image acquisition request for acquiring the image selected; when the first communication means receives the image acquisition request, it transmits one of the infrared camera image, and the visible-light camera image, according to the image acquisition request; and when the second communication means receives the image transmitted from the first communication means, the display means displays the received image.

### TECHNICAL FIELD

The present disclosure relates to a video display system and a video display method.

### BACKGROUND ART

As an example of a video display system, Patent Literature 1 discloses a video display system configured to display an infrared-camera image or a visible-light camera image taken by an infrared camera or a visible-light camera provided in a hood of a protective suit worn by a rescue worker on a display unit installed at a remote place.

### CITATION LIST

### Patent Literature

Patent Literature 1: Japanese Unexamined Patent Application Publication No. 2000-112558

### SUMMARY OF INVENTION

### Technical Problem

However, regarding the system disclosed in Patent Literature 1, it does not propose anything as to how to switch (i.e., select) and display the infrared camera image taken by the infrared camera and the visible-light camera image taken by the visible-light camera.

In view of the above-described problem, an object of the present disclosure is to provide a video display system and a video display method capable of properly switching (i.e., selecting) and displaying an infrared camera image and a visible-light camera image taken by an infrared camera and a visible-light camera, respectively, provided in a mask worn by a subordinate.

### Solution to Problem

A video display system according to a first aspect of the present disclosure includes: a mask configured to be worn by a subordinate who works at a site; an infrared camera disposed on the mask; a visible-light camera disposed on the mask; first communication means disposed on an outfit configured to be worn by the subordinate; and a leader terminal configured to be operated by a leader who leads the subordinate, in which the leader terminal includes: second communication means for communicating with the first communication means; display means; and selecting means for selecting one of an infrared camera image and a visible-light camera image as an image to be displayed, the second communication means transmits an image acquisition request for acquiring the image selected by the selecting means to the first communication means, when the first communication means receives the image acquisition request transmitted from the second communication means, the first communication means transmits, to the leader terminal, one of the infrared camera image and the visible-light camera image according to the image acquisition request, the infrared camera image and the visible-light camera image being images taken by the infrared camera and the visible-light camera, respectively, and when the second communication means receives the image transmitted from the first communication means, the display means displays the received image.

A video display system according to a second aspect of the present disclosure includes: a mask configured to be worn by a subordinate who works at a site; an infrared camera disposed on the mask; a visible-light camera disposed on the mask; first communication means disposed on an outfit configured to be worn by the subordinate; and a leader terminal configured to be operated by a leader who leads the subordinate, in which the leader terminal includes: second communication means for communicating with the first communication means; display means; and selecting means for selecting one of an infrared camera image and a visible-light camera image as an image to be displayed, the first communication means transmits the infrared camera image and the visible-light camera image to the leader terminal, the infrared camera image and the visible-light camera image being images taken by the infrared camera and the visible-light camera, respectively, the second communication means receives the infrared camera image and the visible-light camera image transmitted from the first communication means, and the display means displays one of the infrared camera image and the visible-light camera image, both of which have been received by the second communication means, according to the selection by the selecting means.

A video display system according to a third aspect of the present disclosure includes: a mask configured to be worn by a subordinate who works at a site; an infrared camera disposed on the mask; a visible-light camera disposed on the mask; first communication means disposed on an outfit configured to be worn by the subordinate; a leader terminal configured to be operated by a leader who leads the subordinate; a sensor disposed on the outfit configured to be worn by the subordinate; and first determination means disposed on the outfit configured to be worn by the subordinate, the first determination means being means for determining, based on a result of detection by the sensor, one of an infrared camera image and a visible-light camera image as an image to be transmitted to the leader terminal, in which the leader terminal includes: second communication means for communicating with the first communication means; and display means, the first communication means transmits, to the leader terminal, one of the infrared camera image and the visible-light camera image determined by the first determination means, the infrared camera image and the visible-light camera image being images taken by the infrared camera and the visible-light camera, respectively, the second communication means receives the image transmitted from the first communication means, and when the second communication means receives the image transmitted from the first communication means, the display means displays the received image.

A video display system according to a fourth aspect of the present disclosure includes: a mask configured to be worn by a subordinate who works at a site; an infrared camera disposed on the mask; a visible-light camera disposed on the mask; first communication means disposed on an outfit configured to be worn by the subordinate; and a leader terminal configured to be operated by a leader who leads the subordinate; and a sensor disposed on the outfit configured to be worn by the subordinate, in which the leader terminal includes: second communication means for communicating with the first communication means; display means; and second determination means for determining, based on a result of detection by the sensor received by the second communication means, one of an infrared camera image and a visible-light camera image as an image to be displayed, the first communication means transmits the infrared camera image, the visible-light camera image, and the result of the detection by the sensor to the leader terminal, the infrared camera image and the visible-light camera image being images taken by the infrared camera and the visible-light camera, respectively, the second communication means receives the infrared camera image, the visible-light camera image, and the result of the detection by the sensor transmitted from the first communication means, and the display means displays the one of the infrared camera image and the visible-light camera image determined as the image to be displayed by the second communication means, received by the second communication means.

A video display method according to a fifth aspect of the present disclosure is a method performed in a video display system, the video display system comprising: a mask configured to be worn by a subordinate who works at a site; an infrared camera disposed on the mask; a visible-light camera disposed on the mask; first communication means disposed on an outfit configured to be worn by the subordinate; and a leader terminal configured to be operated by a leader who leads the subordinate, the leader terminal including: second communication means for communicating with the first communication means; display means, the video display method including: a selecting step of selecting one of an infrared camera image and a visible-light camera image as an image to be displayed; a first transmitting step of, by the second communication means, transmitting an image acquisition request for acquiring the image selected in the selecting step to the first communication means; a second transmitting step of, when the first communication means receives the image acquisition request transmitted in the transmitting step, transmitting, to the leader terminal, one of the infrared camera image and the visible-light camera image according to the image acquisition request, the infrared camera image and the visible-light camera image being images taken by the infrared camera and the visible-light camera, respectively, and a displaying step of, by the display means, when the second communication means receives the image transmitted from the first communication means, displaying the received image.

### Advantageous Effects of Invention

According to the present invention, it is possible to provide a video display system and a video display method capable of properly switching (i.e., selecting) and displaying an infrared camera image and a visible-light camera image taken by an infrared camera and a visible-light camera, respectively, provided in a mask worn by a subordinate.

### BRIEF DESCRIPTION OF DRAWINGS

FIG. 1 is a schematic configuration diagram of a video display system 1;

FIG. 2 is a flowchart of an example of operations performed by the video display system 1;

FIG. 3 is a detailed configuration diagram of the video display system 1;

FIG. 4 shows an example (a front view) of a smart mask 10;

FIG. 5 shows an example of a screen G1 (a virtual image) visually recognized as a virtual image by a member of a fire brigade wearing the smart mask 10;

FIG. 6 shows an example of a screen G2 (a browser screen) displayed on a display 25;

FIG. 7 is an enlarged view of one camera image display area b shown in FIG. 6;

FIG. 8 is a flowchart of operations (a video switching process 1) performed by the video display system 1;

FIG. 9 is a flowchart of operations (a video switching process 2) performed by the video display system 1;

FIG. 10 is a detailed configuration diagram of a video display system 1A;

FIG. 11 is a flowchart of operations (a video switching process 3) performed by the video display system 1A;

FIG. 12 is a detailed configuration diagram of a video display system 1B;

FIG. 13 is a detailed configuration diagram of a video display system 1C;

FIG. 14 is a flowchart of operations (a video switching process 5) performed by the video display system 1C; and

FIG. 15 is a detailed configuration diagram of a video display system 1D.

### EXAMPLE EMBODIMENTS

### First Example Embodiment

A video display system 1 according to a first example embodiment of the present invention will be described hereinafter with reference to the accompanying drawings. The same reference numerals (or symbols) are assigned to corresponding elements throughout the drawings, and redundant descriptions thereof are omitted as appropriate.

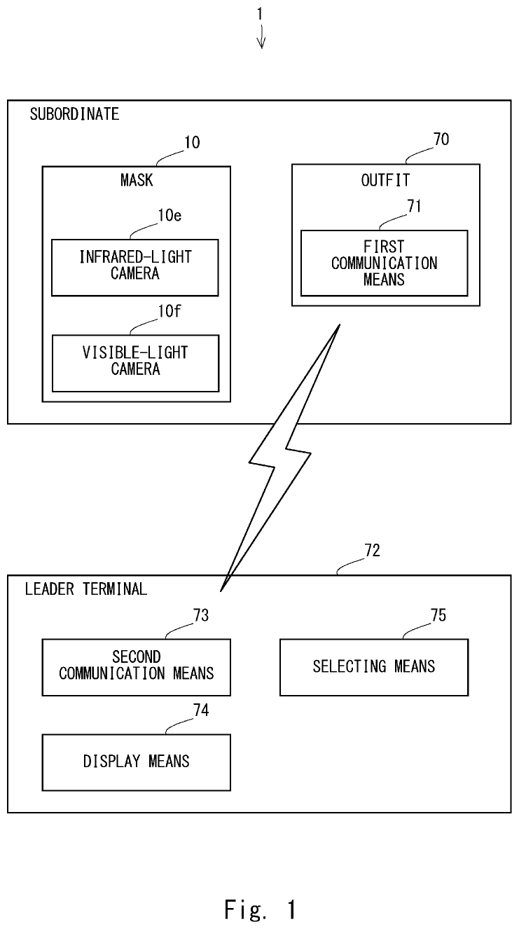

Firstly, a configuration of the video display system 1 will be described with reference to FIG. 1.

FIG. 1 is a schematic diagram of the video display system 1.

As shown in FIG. 1, the video display system 1 includes a smart mask 10, which is a mask worn by a subordinate who works at a site, an infrared camera 10e disposed in the smart mask 10, a visible-light camera 10f disposed in the smart mask 10, first communication means 71 disposed in an outfit 70 worn by the subordinate, and a leader terminal 72 that is operated by a leader who leads the subordinate. The leader terminal 72 includes second communication means 73 for communicating with the first communication means 71, display means 74, and selecting means 75 for selecting one of an infrared camera image and a visible-light camera image as an image to be displayed.

The second communication means 73 transmits an image acquisition request for acquiring the video selected by the selecting means 75 to the first communication means 71. When the first communication means 71 receives the image acquisition request transmitted from the second communication means 73, the first communication means 71 transmits, to the leader terminal 72, one of the infrared camera image, which is taken by the infrared camera 10e, and the visible-light camera image, which is taken by the visible-light camera 10f, according to the image acquisition request. When the second communication means 73 receives the image transmitted from the first communication means 71, the display means 74 displays the received image.

Next, an example of operations performed by the video display system 1 having the above-described configuration will be described.

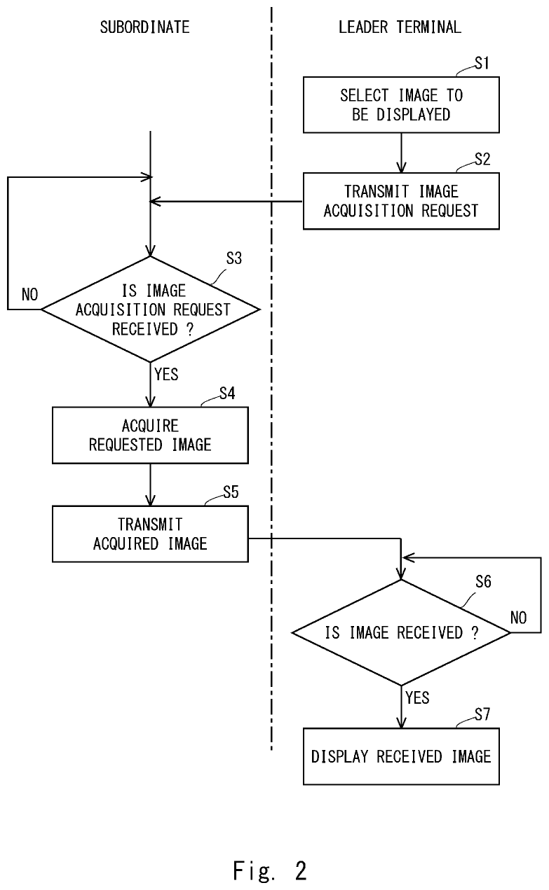

FIG. 2 is a flowchart of an example of operations performed by the video display system 1.

Firstly, the subordinate is made to select one of the infrared camera image and the visible-light camera image as an image to be displayed (Step S1).

Next, the second communication means 73 transmits an image acquisition request for acquiring the image selected in the step S1 to the first communication means 71 (Step S2).

Next, when the first communication means 71 receives the image acquisition request transmitted in the step S2 (Step S3: Yes), the first communication means 71 acquires one of the infrared camera image, which has been taken by the infrared camera 10e, and the visible-light camera image, which has been taken by the visible-light camera, according to the image acquisition request (Step S4), and transmits the acquired image to the leader terminal 72 (Step S5).

Next, when the second communication means 73 receives the image transmitted from the first communication means 71 (Step S6: Yes), the display means 74 displays the received image (Step S7).

According to the first example embodiment, it is possible to properly switch (i.e., select) and display the infrared camera image or the visible-light camera image taken by the infrared camera 10e or the visible-light camera 10f provided in the smart mask 10, which is the mask worn by the subordinate.

### Second Example Embodiment

As a second example embodiment of the present invention, the video display system 1 will be described hereinafter in a more detailed manner. An example in which the subordinate is a member of a fire brigade and the leader is the leader of the fire brigade (or the captain of the fire brigade) will be described hereinafter.

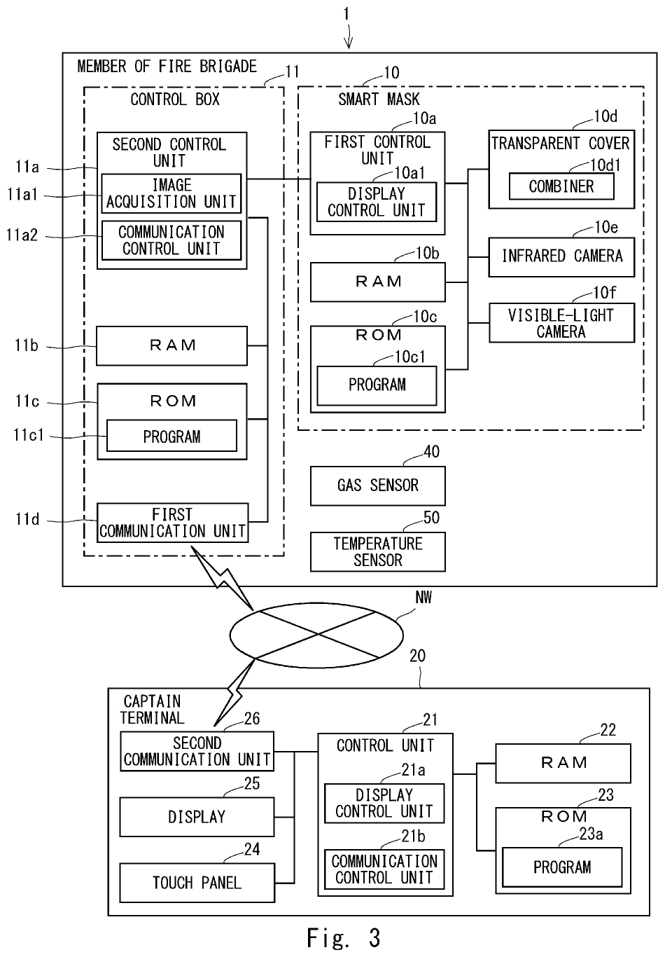

FIG. 3 is a detailed configuration diagram of the video display system 1.

As shown in FIG. 3, in the second example embodiment, a first communication unit 11d is used as the first communication means 71, and a captain terminal 20 is used as the leader terminal 72. A second communication unit 26 is used as the second communication means 73, and a display control unit 21a is used as the display means 74. Further, a touch panel 24 is used as the selecting means 75.

As shown in FIG. 3, the video display system 1 includes the smart mask 10, a control BOX 11, a gas sensor 40, a temperature sensor 50, and the captain terminal 20.

Firstly, the configuration of the smart mask 10 will be described.

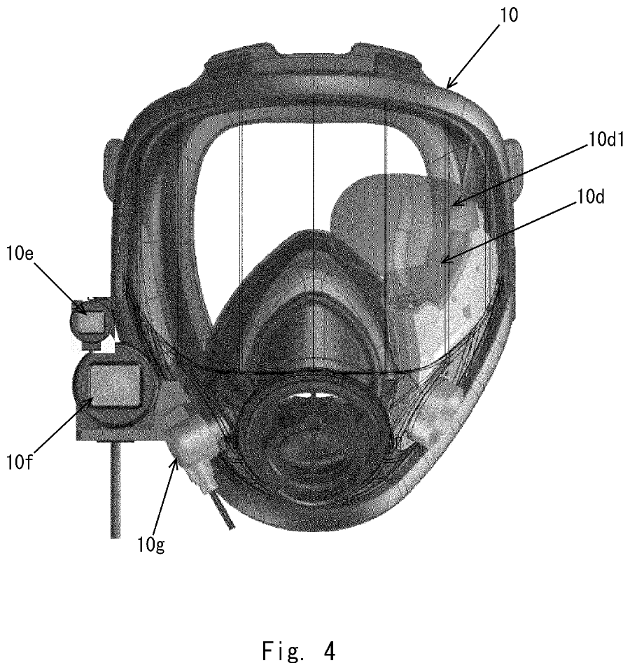

The smart mask 10 is a mask worn by a member of a fire brigade who works at a fire site, and as shown in FIG. 3, includes a first control unit 10a, a RAM (Random Access Memory) 10b, a ROM (Read Only Memory) 10c, a transparent cover 10d, an infrared camera 10e, and a visible-light camera 10f. The transparent cover 10d, the infrared camera 10e, and the visible-light camera 10f are arranged as shown in FIG. 4. FIG. 4 shows an example (a front view) of the smart mask 10.

The first control unit 10a includes a processor (not shown). The processor is, for example, a CPU (Central Processing Unit). The first control unit 10a may include only one processor or may include a plurality of processors. The processor functions as a display control unit 10a1 by executing a program 10c1 loaded from the ROM 10c into the RAM 10b. The display control unit 10a1 may be implemented by hardware.

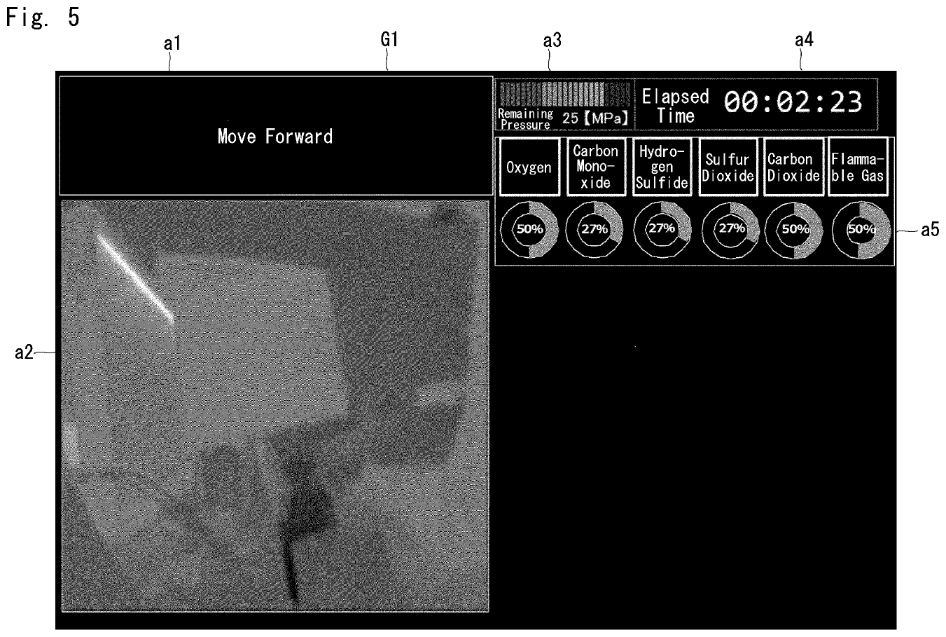

The display control unit 10a1 displays (e.g., forms) an image that is projected onto the transparent cover 10d (a combiner 10d1) and visually recognized as a virtual image, e.g., displays (e.g., forms) a screen G1 (i.e., a window G1) shown in FIG. 5.

The transparent cover 10d is disposed in front of the face of the member of the fire brigade in a state in which the smart mask 10 is worn by the member of the fire brigade. The transparent cover 10d includes a reflective and transmissive member (e.g., a combiner 10d1). Various screens (i.e., various windows) (e.g., the screen G1 shown in FIG. 5) generated by the display control unit 10a1 or the like are projected onto the combiner 10d1 by using a known optical system. These various images projected onto the combiner 10d1 are reflected (and enlarged) by the combiner 10d1, and reach the eyes of the member of the fire brigade wearing the smart mask 10. As a result, the member of the fire brigade wearing the smart mask 10 visually recognizes the various screens (e.g., the screen G1 shown in FIG. 5) as enlarged virtual images as if they are floating in front of (e.g., 1.5 m in front of) him/her. Since the various screens (the virtual images) overlap with the field of view of the member of the fire brigade wearing the smart mask 10, the member of the fire brigade can view the various screens (the virtual images) without widely (or substantially) moving his/her line of sight. Note that since a known optical system can be used as the optical system for projecting the various screens, the description thereof will be omitted. Note that the transparent cover 10d (the combiner 10d1), the display control unit 10a1 that generates the various screens to be projected onto the combiner 10d1, and the optical system that projects the generated various screens may be collectively referred to as a head-mounted display (or a head-up display).

That is, an apparatus or a system capable of displaying a screen visually recognized by the member of the fire brigade wearing the smart mask 10 may be referred to as a head-mounted display (or a head-up display).

FIG. 5 shows an example of a screen G1 (a virtual image) visually recognized as a virtual image by the member of the fire brigade wearing the smart mask 10.

As shown in FIG. 5, the screen G1 includes a remote support message display area a1, a camera image display area a2, an air cylinder remaining amount (remaining pressure) display area a3, an entry elapsed time display area a4, and a detection target gas concentration display area a5.

In the remote support message display area a1, various messages (e.g., Move Forward) transmitted from the captain terminal 20 are displayed.

In the camera image display area a2, the infrared camera image taken by the infrared camera 10e is displayed

In the air cylinder remaining amount (remaining pressure) display area a3, the remaining amount (the remaining pressure) of an air cylinder carried on the back of the member of the fire brigade is displayed.

In the entry elapsed time display area a4, the time that has elapsed after the member of the fire brigade entered the fire site is displayed.

In the detection target gas concentration display area a5, the concentrations of various gases, which are the results of the detection by the gas sensor(s) 40, are displayed.

The infrared camera 10e shoots (e.g., takes moving images of) the environment in which the members of the fire brigade work (i.e., are working) based on infrared light received by the infrared camera 10e. In the following description, an image (e.g., a moving image) taken by the infrared camera 10e will be referred to as an infrared camera image. The visible-light camera 10f shoots the environment in which the members of the fire brigade work based on visible light received by the visible-light camera 10f. In the following description, an image (e.g., a moving image) taken by the visible-light camera 10f will be referred to as a visible-light camera image.

The gas sensor(s) 40 and the temperature sensor 50 are attached to an outfit (e.g., a fire suit or the smart mask 10) worn by the member of the fire brigade.

The gas sensor(s) 40 detects the concentration(s) of a gas(es) in the environment in which the members of the fire brigade work. The gas sensor 40 is, for example, an oxygen sensor for detecting the concentration of oxygen, a carbon monoxide sensor for detecting the concentration of carbon monoxide, a hydrogen sulfide sensor for detecting the concentration of hydrogen sulfide, a sulfur dioxide sensor for detecting the concentration of sulfur dioxide, and/or a flammable gas sensor for detecting the concentration of a flammable gas(es).

The temperature sensor 50 detects the temperature in the environment in which the members of the fire brigade work.

Next, the configuration of the control BOX 11 will be described.

As shown in FIG. 3, the control BOX 11 includes a second control unit 11a, a RAM 11b, a ROM 11c, and the first communication unit 11d.

The second control unit 11a includes a processor (not shown). The processor is, for example, a CPU (Central Processing Unit). The second control unit 11a may include only one processor or may include a plurality of processors. The processor function as an image acquisition unit 11a1 and a communication control unit 11a2 by executing a program 11c1 loaded from the ROM 11c into the RAM 11b. Some or all of these units and the like may be implemented by hardware.

The image acquisition unit 11a1 acquires an image (video data) taken by at least one of the infrared camera 10e and the visible-light camera 10f.

The communication control unit 11a2 controls the first communication unit 11d so that, for example, an image acquired by image acquisition unit 11a1 is transmitted to the captain terminal.

The first communication unit 11d is a communication apparatus that wirelessly communicates with the captain terminal 20 through a communication line NW (e.g., the Internet).

Next, the configuration of the captain terminal 20 will be described.

The captain terminal 20 is, for example, a tablet-type information processing terminal operated by the leader (i.e., the captain) of the fire brigade, and as shown in FIG. 3, includes a control unit 21, a RAM 22, a ROM 23, a touch panel 24, a display 25, and a second communication unit 26.

The control unit 21 includes a processor (not shown). The processor is, for example, a CPU. The control unit 21 may include only one processor or may include a plurality of processors. The processor functions as a display control unit 21a and a communication control unit 21b by executing a program 23a (including, for example, a browser program) loaded from the ROM 23 into the RAM 22. Some or all of these units and the like may be implemented by hardware.

The display control unit 21a controls the display 25 so that an image transmitted from the control BOX 11 (the first communication unit 11d) is displayed thereon. For example, the display control unit 21a displays a browser screen (i.e., a browser window) including an image transmitted from the control BOX 11 (the first communication unit 11d) on the display 25.

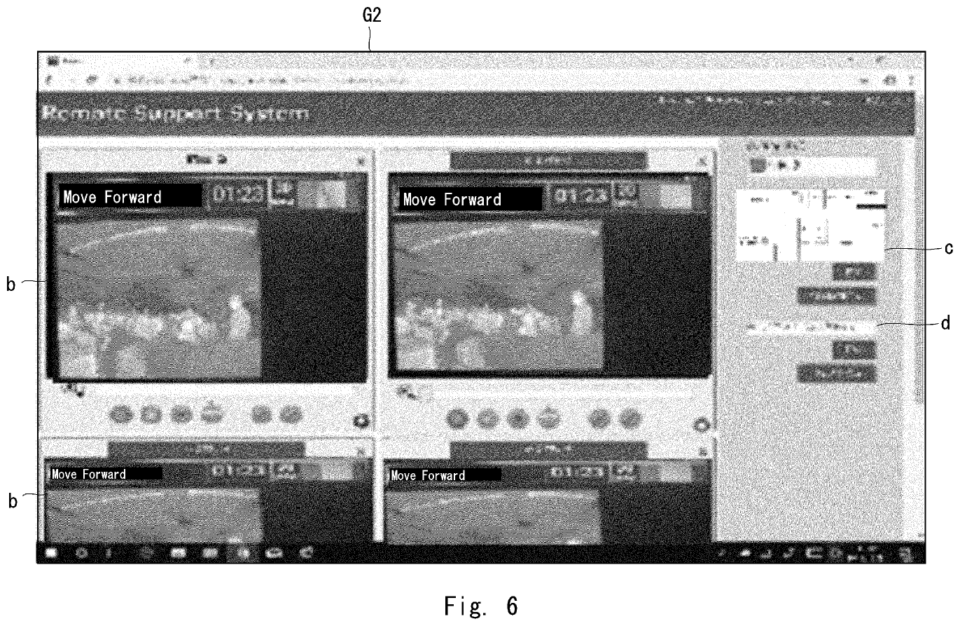

FIG. 6 shows an example of a screen G2 (a browser screen) displayed on the display 25.

As shown in FIG. 6, the screen G2 includes camera image display areas b, a drawing and photograph information display area c, and a message transmission area d.

In the camera image display areas b, images transmitted from the control BOX 11 (the first communication unit 11d) are displayed. In FIG. 6, four camera image display areas b corresponding to four members of the fire brigade are displayed.

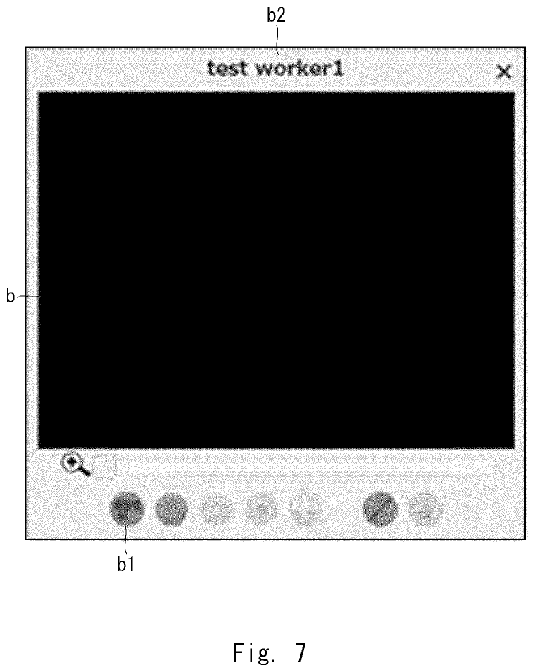

FIG. 7 is an enlarged view of one of the camera image display areas b shown in FIG. 6.

As shown in FIG. 7, an image switching button b1 is displayed below each of the camera image display areas b. By tapping the image switching button b1 through the touch panel 24, it is possible to select (switch) an image (an infrared camera image or a visible-light camera image) to be displayed in the camera image display area b. Further, above each of the camera image display areas b, identification information b2 (e.g., a name or the like) for identifying the member of the fire brigade on whom the camera that is taking the image displayed in that camera image display area b is disposed (e.g., attached) is displayed.

In the drawing and photograph information display area c, for example, drawing data or photograph data of the disaster site is displayed.

In the message transmission area d, for example, a message to be transmitted to the member of the fire brigade is displayed. Further, it is also possible to transmit a message through the touch panel 24.

As described above, the captain terminal 20 is configured so that the leader can recognize and manage information about the working performed by the members of the fire brigade from a remote place.

The communication control unit 21b controls the second communication unit 26 so as to, for example, transmit an image acquisition request requesting the acquisition of an image (an infrared camera image or a visible-light camera image) selected through the touch panel 24 to the control BOX 11 (the first communication unit 11d).

The touch panel 24 is an input device operated by the leader of the fire brigade, and is disposed so as to cover the display surface of the display 25. The touch panel 24 is an example of the selecting means according to the present invention. The display 25 is, for example, a display equipped with the touch panel 24. A display equipped with a touch panel is also called a touch screen display.

The second communication unit 26 is a communication apparatus that wirelessly communicates with the control BOX 11 (the first communication unit 11d) through the communication line NW (e.g., the Internet).

Next, as an example of operations performed by the video display system 1 having the above-described configuration, an image switching process 1 for switching (i.e., selecting) and displaying an infrared camera image taken by the infrared camera 10e and a visible-light camera image taken by the visible-light camera 10f will be described.

The image switching process 1 is a process through which the control BOX 11 transmits only an image that is determined according to the image acquisition request transmitted from the captain terminal 20 to the captain terminal 20, and the captain terminal 20 displays the image transmitted from the control BOX 11 on the display 25.

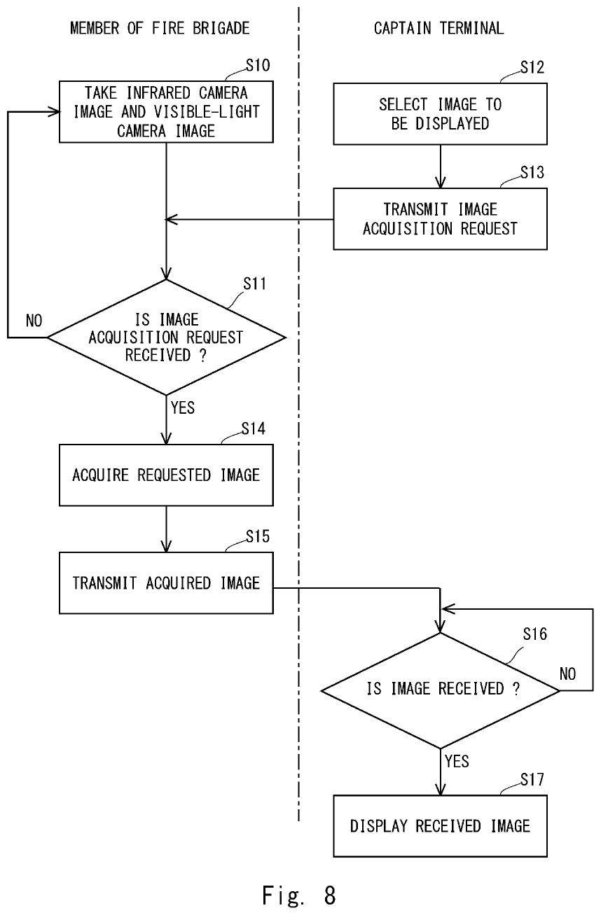

FIG. 8 is a flowchart of operations (the image switching process 1) performed by the video display system 1.

When the control BOX 11 is powered up, the infrared camera 10e starts taking an infrared camera image, and the visible-light camera 10f starts taking a visible-light camera image (Step S10). In this process, the screen G1 (see FIG. 5) including the infrared camera image taken in the step S10 is projected onto the combiner 10d1, is reflected (and enlarged) by the combiner 10d1, and reaches the eyes of the member of the fire brigade wearing the smart mask 10. As a result, the member of the fire brigade wearing the smart mask 10 can visually recognize the infrared camera image taken in the step S10 as an enlarged virtual image as if it is floating in front of (e.g., 1.5 m in front of) the member of the fire brigade.

Here, it is assumed that, in the step S12, the leader of the fire brigade has selected the infrared camera image as the image to be displayed on the display 25 by tapping the image switching button b1 (see FIG. 7) through the touch panel 24.

In this case, the captain terminal 20 (the communication control unit 21b) wirelessly transmits an image acquisition request requesting the acquisition of the image selected in the step S12 (in this example, the infrared camera image) to the control BOX 11 (the first communication unit 11d) by controlling the second communication unit 26 (Step S13).

Next, when the control BOX 11 (the first communication unit 11d) receives the image acquisition request transmitted from the captain terminal 20 (Step S11: Yes), it transmits an image that is determined according to the image acquisition request to the captain terminal 20. Specifically, firstly, the control BOX 11 (the image acquisition unit 11a1) acquires the infrared camera image requested by the image acquisition request received in the step S11 from the infrared camera 10e (Step S14).

Next, the control BOX 11 (the communication control unit 11a2) wirelessly transmits the infrared camera image acquired in the step S14 to the captain terminal 20 by controlling the first communication unit 11d (Step S15).

Next, when the captain terminal 20 (the second communication unit 26) receives the image transmitted from the control BOX 11 (the first communication unit 11d) (in this example, the infrared camera image) (Step S16: Yes), the captain terminal 20 (the display control unit 21a) displays the image received in the step S16 (in this example, the infrared camera image) on the display 25 (e.g., in corresponding one of the camera image display areas b shown in FIG. 6) (Step S17).

Further, it is assumed that, on the other hand, the leader of the fire brigade has selected the visible-light camera image as the image to be displayed on the display 25 by tapping the image switching button b1 (see FIG. 6) through the touch panel 24 in the step S12.

In this case, the captain terminal 20 (the communication control unit 21b) wirelessly transmits an image acquisition request requesting the acquisition of the image selected in the step S12 (in this example, the visible-light camera image) to the control BOX 11 (the first communication unit 11d) by controlling the second communication unit 26 (Step S13).

Next, when the control BOX 11 (the first communication unit 11d) receives the image acquisition request transmitted from the captain terminal 20 (Step S11: Yes), it transmits an image that is determined according to the image acquisition request to the captain terminal 20. Specifically, firstly, the control BOX 11 (the image acquisition unit 11a1) acquires the visible-light camera image requested by the image acquisition request received in the step S11 from the visible-light camera 10f (Step S14).

Next, the control BOX 11 (the communication control unit 11a2) wirelessly transmits the visible-light camera image acquired in the step S14 to the captain terminal 20 by controlling the first communication unit 11d (Step S15).

Next, when the captain terminal 20 (the second communication unit 26) receives the image transmitted from the control BOX 11 (the first communication unit 11d) (in this example, the visible-light camera image) (Step S16: Yes), the captain terminal 20 (the display control unit 21a) displays the image received in the step S16 (in this example, a visible-light camera image) on the display 25 (e.g., in corresponding one of the camera image display areas b shown in FIG. 6) (Step S17).

Note that, in step S15, when the control BOX 11 transmits the image that is determined according to the image acquisition request to the captain terminal 20, it may perform a trimming process for trimming the image to a predetermined size and then transmit the trimmed image to the captain terminal 20. The same applies to image switching processes 2 to 6 described later. In this way, it is possible to reduce the amount of transmission data required to transmit the image (reduction in the transmission data volume).

Further, in the step S17, when the captain terminal 20 (the display control unit 21a) displays the image received in the step S16 on the display 25, it may perform a rotation process for rotating the image and then display the rotated image on the display 25 (in the case where the image received in the step S16 is taken in an inclined state). The same applies to image switching processes 2 to 6 described later. By performing the trimming process and the rotation process in a distributed manner as described above, it is possible to reduce the load on each of the control units as compared to the case where the trimming process and the rotation process are performed in only one of the control BOX 11 and the captain terminal 20. Further, the power consumption can also be reduced.

Next, as an example of operations performed by the video display system 1 having the above-described configuration, an image switching process 2 for switching (i.e., selecting) and displaying an infrared camera image taken by the infrared camera 10e and a visible-light camera image taken by the visible-light camera 10f will be described.

The image switching process 2 is a process through which the control BOX 11 transmits both an infrared camera image and a visible-light camera image to the captain terminal 20, and the captain terminal 20 displays, on the display 25, only one of the infrared camera image and the visible-light camera image, which have transmitted from the control BOX 11, selected by the leader of the fire brigade.

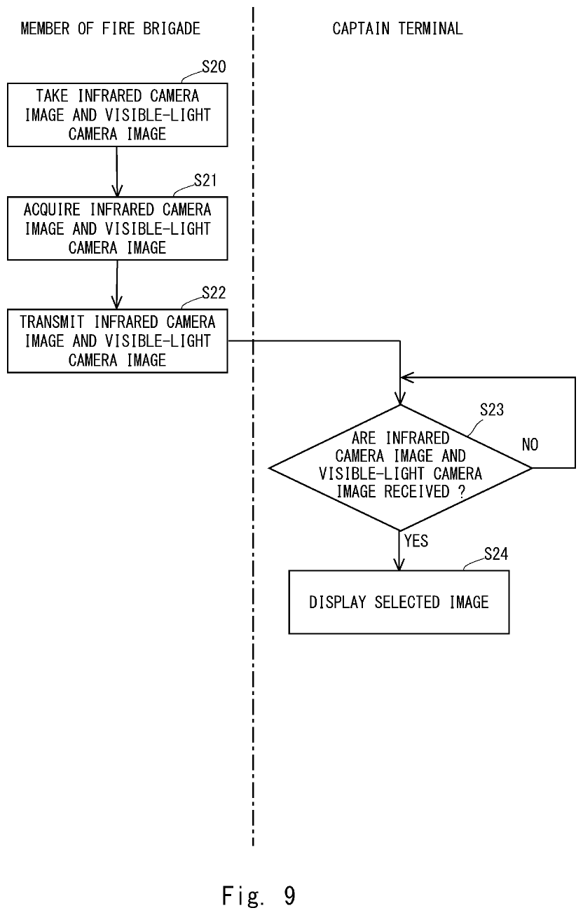

FIG. 9 is a flowchart of operations (the image switching process 2) performed by the video display system 1.

When the control BOX 11 is powered up, the infrared camera 10e starts taking an infrared camera image, and the visible-light camera 10f starts taking a visible-light camera image (Step S20). In this process, the screen G1 (see FIG. 5) including the infrared camera image taken in the step S20 is projected onto the combiner 10d1, is reflected (and enlarged) by the combiner 10d1, and reaches the eyes of the member of the fire brigade wearing the smart mask 10. As a result, the member of the fire brigade wearing the smart mask 10 can visually recognize the infrared camera image taken in the step S20 as an enlarged virtual image as if it is floating in front of (e.g., 1.5 m in front of) the member of the fire brigade.

Next, the control BOX 11 (the first communication unit 11d) transmits both an infrared camera image taken by the infrared camera 10e and a visible-light camera image taken by the visible-light camera 10f to the captain terminal 20. Specifically, firstly, the control BOX 11 (the image acquisition unit 11a1) acquires an infrared camera image from the infrared camera 10e and acquires a visible-light camera image from the visible-light camera 10f (Step S21).

Next, the control BOX 11 (the communication control unit 11a2) wirelessly transmits both the infrared camera image (video data) and the visible-light camera image (video data) acquired in the step S21 to the captain terminal 20 by controlling the first communication unit 11d (Step S22).

Next, when the captain terminal 20 (the second communication unit 26) receives the images transmitted from the control BOX 11 (the first communication unit 11d) (in this example, the infrared camera image and the visible-light camera image) (Step S23: Yes), the captain terminal 20 (the display control unit 21a) displays, on the display 25, one of the images received in the step S23 (in this example, the infrared camera image and the visible-light camera image) selected by the leader of the fire brigade (Step S24).

For example, it is assumed that the leader of the fire brigade has selected the infrared camera image as the image to be displayed on the display 25 by tapping the image switching button b1 (see FIG. 7) through the touch panel 24.

In this case, the captain terminal 20 (the display control unit 21a) displays, on the display 25 (e.g., in corresponding one of the camera image display areas b shown in FIG. 6), one of the images received in the step S23 (in this example, the infrared camera image and the visible-light camera image) selected by the leader of the fire brigade.

Further, it is assumed that, on the other hand, the leader of the fire brigade has selected the visible-light camera image as the image to be displayed on the display 25 by tapping the image switching button b1 (see FIG. 7) through the touch panel 24.

In this case, the captain terminal 20 (the display control unit 21a) displays, on the display 25 (e.g., in corresponding one of the camera image display areas b shown in FIG. 6), one of the images received in the step S23 (in this example, the infrared camera image and the visible-light camera image) selected by the leader of the fire brigade (i.e., in this example, displays the visible-light camera image).

According to the second example embodiment, the leader of the fire brigade can appropriately switch (i.e., select) and display the infrared camera image or the visible-light camera image taken by the infrared camera 10e or the visible-light camera 10f provided in the smart mask 10, which is a mask worn by the member of the fire brigade, by tapping the image switching button b1 (see FIG. 7) through the touch panel 24.

Further, according to the image switching process 1, only the image that is determined according to the image acquisition request is transmitted to the captain terminal 20, so that it is possible to reduce the amount of transmission data required to transmit the image as compared to that required in the image switching process 2 in which both the infrared camera image and the visible-light camera image are transmitted (reduction in the transmission data volume).

Further, according to the second example embodiment (the image switching process 1), when the leader of the fire brigade selects an image to be displayed on the display 25 by tapping the image switching button b1 (see FIG. 7) through the touch panel 24 (Step S12), an image acquisition request requesting the acquisition of this selected image is wirelessly transmitted to each of a plurality of control BOXes 11 (e.g., the control BOX 11 of a member A of the fire brigade and the control BOX 11 of a member B of the fire brigade) (Step S13), so that it is possible to simultaneously switch (i.e., select) and display a plurality of images by one operation performed by the leader of the fire brigade.

### Third Example Embodiment

A video display system 1A according to a third example embodiment of the present invention will be described hereinafter.

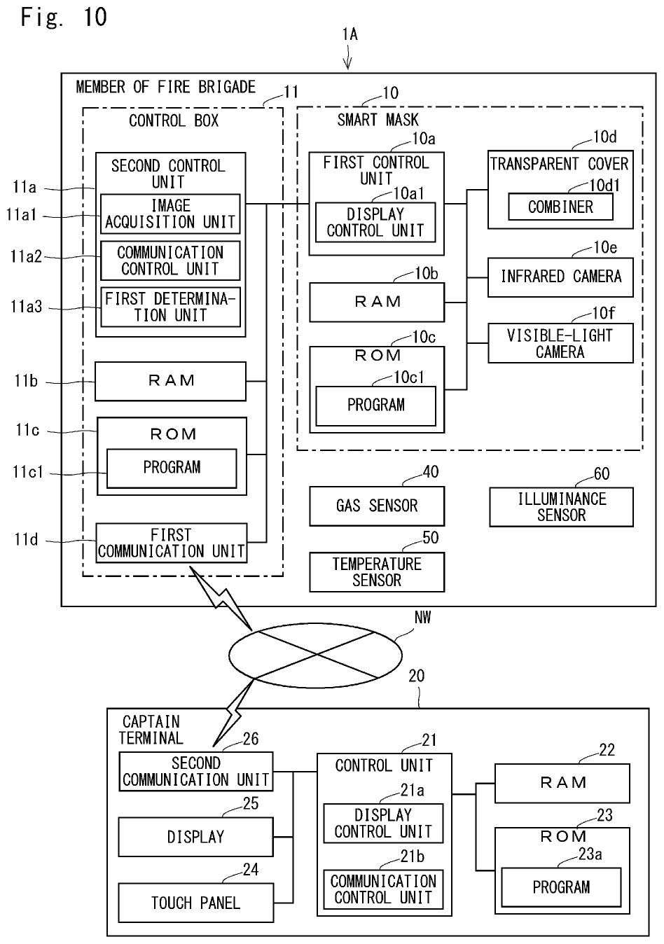

FIG. 10 is a detailed configuration diagram of the video display system 1A. The video display system 1A according to the third example embodiment corresponds to one that is obtained by adding an illuminance sensor 60 and a first determination unit 11a3 in the video display system 1 according to the second example embodiment shown in FIG. 3. The other components/structures are similar to those of the video display system 1 according to the second example embodiment. In the following description, the illuminance sensor 60 and the first determination unit 11a3, which are differences, will be mainly described, and descriptions of the other components/structures will be omitted.

The illuminance sensor 60 is attached to an outfit (e.g., a fire suit or the smart mask 10) worn by the member of the fire brigade. The illuminance sensor 60 detects an illuminance in the environment in which the members of the fire brigade work. The illuminance sensor 60 is an example of the sensor according to the present invention.

The first determination unit 11a3 is implemented by having the second control unit 11a (the processor) execute a program 11c1 loaded from the ROM 11c into the RAM 11b. The first determination unit 11a3 may be implemented by hardware.

The first determination unit 11a3 determines, based on the result of the detection by the illuminance sensor 60, one of the infrared camera image and the visible-light camera image as an image to be transmitted to the captain terminal 20. For example, when the illuminance, which is the result of the detection by the illuminance sensor 60, has decreased below a threshold (i.e., when the member of the fire brigade can no longer get an unobstructed view in the environment in which he/she works due to smoke or the like), the first determination unit 11a3 determines (i.e., selects) the infrared camera image as the image to be transmitted to the captain terminal 20. Further, when the illuminance, which is the result of the detection by the illuminance sensor 60, has increased above a threshold (i.e., when the member of the fire brigade can get an unobstructed view in the environment in which he/she works again without being affected by smoke or the like), the first determination unit 11a3 determines (i.e., selects) the visible-light camera image as the image to be transmitted to the captain terminal 20.

Next, as an example of operations performed by the video display system 1 having the above-described configuration, an image switching process 3 for switching (i.e., selecting) and displaying an infrared camera image taken by the infrared camera 10e and a visible-light camera image taken by the visible-light camera 10f will be described.

The image switching process 3 is a process through which the control BOX 11 determines an image to be transmitted to the captain terminal 20 based on the result of the detection by the illuminance sensor 60 and transmits only the determined image to the captain terminal 20, and the captain terminal 20 displays the image transmitted from the control BOX 11 on the display 25.

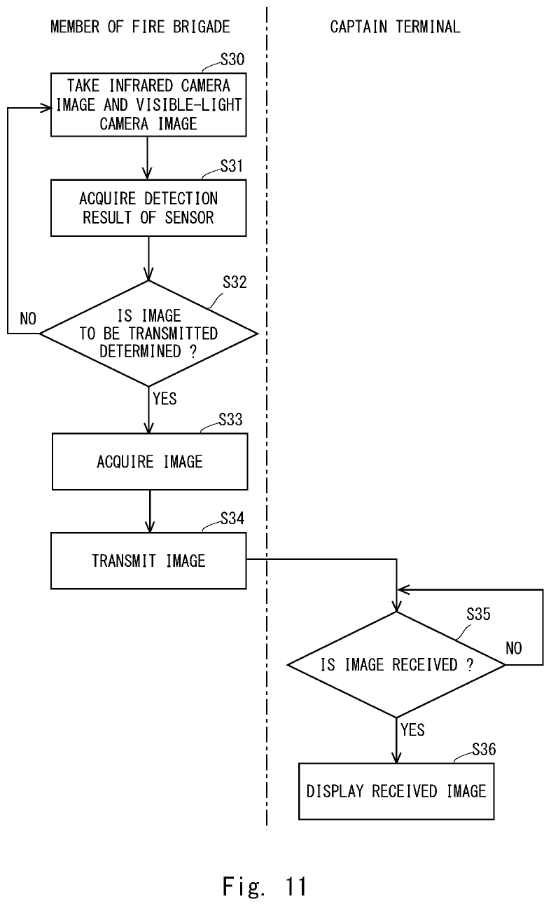

FIG. 11 is a flowchart of operations (the image switching process 3) performed by the video display system 1A.

When the control BOX 11 is powered up, the infrared camera 10e starts taking an infrared camera image, and the visible-light camera 10f starts taking a visible-light camera image (Step S30). In this process, the screen G1 (see FIG. 5) including the infrared camera image taken in the step S30 is projected onto the combiner 10d1, is reflected (and enlarged) by the combiner 10d1, and reaches the eyes of the member of the fire brigade wearing the smart mask 10. As a result, the member of the fire brigade wearing the smart mask 10 can visually recognize the infrared camera image taken in the step S30 as an enlarged virtual image as if it is floating in front of (e.g., 1.5 m in front of) the member of the fire brigade.

Next, the control BOX 11 (the first control unit 10a) acquires the result of the detection by the illuminance sensor 60 (Step S31).

Next, the control BOX 11 (the first determination unit 11a3) determines, based on the result of the detection by the illuminance sensor 60, one of the infrared camera image and the visible-light camera image as an image to be transmitted to the captain terminal 20 (Step S32). For example, when the illuminance, which is the result of the detection by the illuminance sensor 60, has decreased below a threshold (i.e., when the member of the fire brigade can no longer get an unobstructed view in the environment in which he/she works due to smoke or the like), the first determination unit 11a3 determines (i.e., selects) the infrared camera image as the image to be transmitted to the captain terminal 20. On the other hand, when the illuminance, which is the result of the detection by the illuminance sensor 60, has increased above a threshold (i.e., when the member of the fire brigade can get an unobstructed view in the environment in which he/she works again without being affected by smoke or the like), the first determination unit 11a3 determines (i.e., selects) the visible-light camera image as the image to be transmitted to the captain terminal 20. Regarding the threshold for this determination. For example, one stored in the ROM 11c may be used.

Here, it is assumed that the illuminance, which is the result of the detection by the illuminance sensor 60, has decreased below the threshold and hence the infrared camera image has been determined as the image to be transmitted to the captain terminal 20 in the step S32.

In this case, the control BOX 11 (the first communication unit 11d) transmits the image determined in the step S32 (in this example, the infrared camera image) to the captain terminal 20. Specifically, firstly, the control BOX 11 (the image acquisition unit 11a1) acquires the infrared camera image determined in the step S32 from the infrared camera 10e (Step S33).

Next, the control BOX 11 (the communication control unit 11a2) wirelessly transmits the infrared camera image (video data) acquired in the step S33 to the captain terminal 20 by controlling the first communication unit 11d (Step S34).

Next, when the captain terminal 20 (the second communication unit 26) receives the image transmitted from the control BOX 11 (the first communication unit 11d) (in this example, the infrared camera image) (Step S35: Yes), the captain terminal 20 (the display control unit 21a) displays the image received in the step S35 (in this example, the infrared camera image) on the display 25 (e.g., in corresponding one of the camera image display areas b shown in FIG. 6) (Step S36).

In this way, the leader of the fire brigade can view the infrared camera image, which is automatically displayed without having to switch the screen by himself/herself, and therefore can check the environment in which the members of the fire brigade can no longer get an unobstructed view due to smoke or like are working.

On the other hand, when the illuminance, which is the result of the detection by the illuminance sensor 60, has decreased below the threshold and hence the visible-light camera image has been determined as the image to be transmitted to the captain terminal 20 in the step S32, the control BOX 11 (the first communication unit 11d) transmits the image determined in the step S32 (in this example, the visible-light camera image) to the captain terminal 20. Specifically, firstly, the control BOX 11 (the image acquisition unit 11a1) acquires the visible-light camera image determined in the step S32 from the visible-light camera 10f (Step S33).

Next, the control BOX 11 (the communication control unit 11a2) wirelessly transmits the visible-light camera image (video data) acquired in the step S33 to the captain terminal 20 by controlling the first communication unit 11d (Step S34).

Next, when the captain terminal 20 (the second communication unit 26) receives the image transmitted from the control BOX 11 (the first communication unit 11d) (in this example, the visible-light camera image) (Step S35: Yes), the captain terminal 20 (the display control unit 21a) displays the image received in the step S35 (in this example, a visible-light camera image) on the display 25 (e.g., in corresponding one of the camera image display areas b shown in FIG. 6) (Step S36).

In this way, the leader of the fire brigade can view the infrared camera image, which is automatically displayed without having to switch the screen by himself/herself, and therefore can check the environment in which the members of the fire brigade can get an unobstructed view again without being affected by smoke or the like.

According to the third example embodiment, it is possible to appropriately switch (i.e., select) and display the infrared camera image or the visible-light camera image taken by the infrared camera 10e or the visible-light camera 10f provided in the smart mask 10, which is a mask worn by the member of the fire brigade, based on the result of the detection by the illuminance sensor 60.

Further, according to the third example embodiment (the image switching process 3), only the image determined in the step S32 is transmitted to the captain terminal 20, so that it is possible to reduce the amount of transmission data required to transmit the image as compared to that required in the image switching process 2 in which both the infrared camera image and the visible-light camera image are transmitted (reduction in the transmission data volume).

### Fourth Example Embodiment

A video display system 1B according to a fourth example embodiment of the present invention will be described hereinafter.

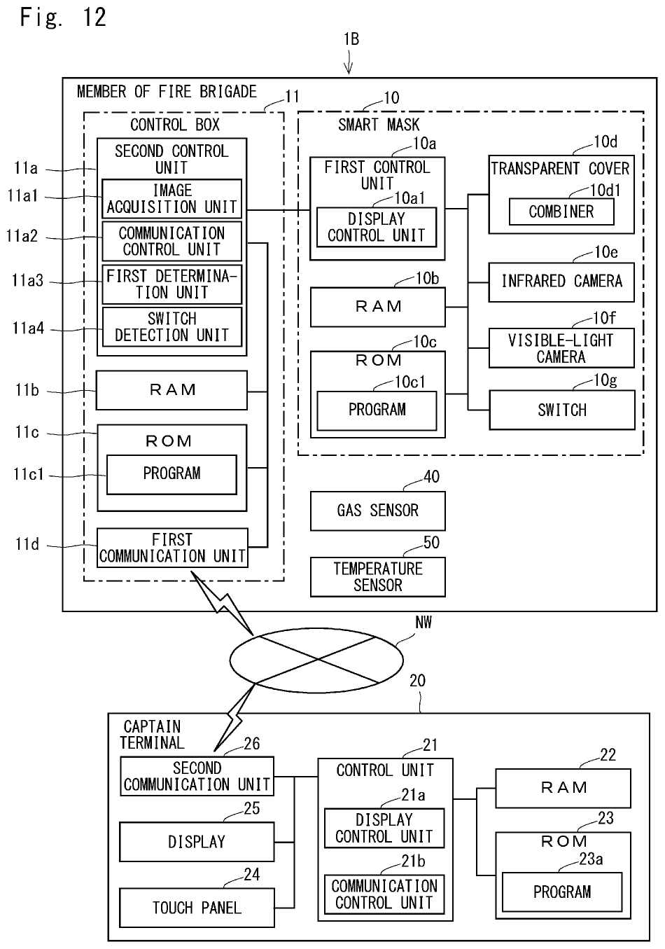

FIG. 12 is a detailed configuration diagram of the video display system 1B. The video display system 1B according to the fourth example embodiment corresponds to one that is obtained by removing the illuminance sensor 60, and adding a switch 10g and a switch detection unit 11a4 in the video display system 1A according to the third example embodiment shown in FIG. 10. The other components/structures are similar to those of the video display system 1A according to the third example embodiment. In the following description, the switch 10g, which is a difference, will be mainly described, and descriptions of the other components/structures will be omitted.

The switch 10g is a switch operated by the member of the fire brigade, and is, for example, a push-button type switch. The switch 10g is disposed, for example, as shown in FIG. 4. For example, the switch 10g is operated and turned on in an emergency (e.g., when the member of the fire brigade is caught in smoke and has difficulty in breathing).

The switch detection unit 11a4 is implemented by having the second control unit 11a (the processor) execute a program 11c1 loaded from the ROM 11c into the RAM 11b. The switch detection unit 11a4 may be implemented by hardware.

The switch detection unit 11a4 detects the On/Off state of the switch 10g. The switch detection unit 11a4 is an example of the sensor according to the present invention.

Next, as an example of operations performed by the video display system 1B having the above-described configuration, an image switching process 4 for switching (i.e., selecting) and displaying an infrared camera image taken by the infrared camera 10e and a visible-light camera image taken by the visible-light camera 10f will be described.

The image switching process 4 is a process through which the control BOX 11 determines an image to be transmitted to the captain terminal 20 based on the result of the detection by the switch detection unit 11a4 and transmits only the determined image to the captain terminal 20, and the captain terminal 20 displays the image transmitted from the control BOX 11 on the display 25.

The image switching process 4 will be described hereinafter with reference to FIG. 11.

When the control BOX 11 is powered up, the infrared camera 10e starts taking an infrared camera image, and the visible-light camera 10f starts taking a visible-light camera image (Step S30). In this process, the screen G1 (see FIG. 5) including the infrared camera image taken in the step S30 is projected onto the combiner 10d1, is reflected (and enlarged) by the combiner 10d1, and reaches the eyes of the member of the fire brigade wearing the smart mask 10. As a result, the member of the fire brigade wearing the smart mask 10 can visually recognize the infrared camera image taken in the step S30 as an enlarged virtual image as if it is floating in front of (e.g., 1.5 m in front of) the member of the fire brigade.

Next, the control BOX 11 (the first control unit 10a) acquires the result of the detection by the switch detection unit 11a4 (Step S31).

Next, the control BOX 11 (the first determination unit 11a3) determines, based on the result of the detection by the switch detection unit 11a4, one of the infrared camera image and the visible-light camera image as an image to be transmitted to the captain terminal 20 (Step S32). For example, when the On state of the switch 10g is detected by the switch detection unit 11a4 (e.g., when the member of the fire brigade is caught in smoke and has difficulty in breathing), the first determination unit 11a3 determines the infrared camera image as the image to be transmitted to the captain terminal 20.

Next, the control BOX 11 (the first communication unit 11d) transmits the image determined in the step S32 (in this example, the infrared camera image) to the captain terminal 20. Specifically, firstly, the control BOX 11 (the image acquisition unit 11a1) acquires the infrared camera image determined in the step S32 from the infrared camera 10e (Step S33).

Next, the control BOX 11 (the communication control unit 11a2) wirelessly transmits the infrared camera image (video data) acquired in the step S33 to the captain terminal 20 by controlling the first communication unit 11d (Step S34).

Next, when the captain terminal 20 (the second communication unit 26) receives the image transmitted from the control BOX 11 (the first communication unit 11d) (in this example, the infrared camera image) (Step S35: Yes), the captain terminal 20 (the display control unit 21a) displays the image received in the step S35 (in this example, the infrared camera image) on the display 25 (e.g., in corresponding one of the camera image display areas b shown in FIG. 6) (Step S36).

In this way, the leader of the fire brigade can view the infrared camera image, which is automatically displayed without having to switch the screen by himself/herself, and therefore can check the environment in which the members of the fire brigade can no longer get an unobstructed view due to smoke or like are working.

Note that, in the step S32, the visible-light camera image may be determined as the image to be transmitted to the captain terminal 20.

According to the fourth example embodiment, it is possible to appropriately switch (i.e., select) and display the infrared camera image or the visible-light camera image taken by the infrared camera 10e or the visible-light camera 10f provided in the smart mask 10, which is a mask worn by the member of the fire brigade, based on the result of the detection by the switch detection unit 11a4.

Further, according to the fourth example embodiment (the image switching process 4), only the image determined in the step S32 is transmitted to the captain terminal 20, so that it is possible to reduce the amount of transmission data required to transmit the image as compared to that required in the image switching process 2 in which both the infrared camera image and the visible-light camera image are transmitted (reduction in the transmission data volume).

### Fifth Example Embodiment

A video display system 1C according to a fifth example embodiment of the present invention will be described hereinafter.

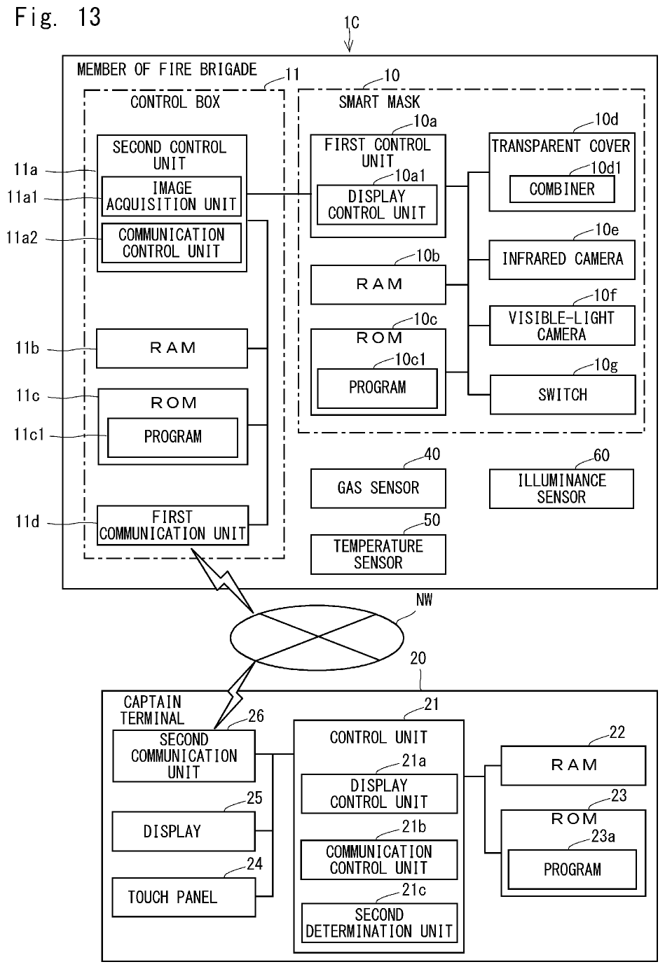

FIG. 13 is a detailed configuration diagram of the video display system 1C. The video display system 1C according to the fifth example embodiment corresponds to one that is obtained by removing the first determination unit 11a3, and adding a second determination unit 21c in the video display system 1A according to the third example embodiment shown in FIG. 10. The other components/structures are similar to those of the video display system 1A according to the third example embodiment. In the following description, the second determination unit 21c, which is a difference, will be mainly described, and descriptions of the other components/structures will be omitted.

The second determination unit 21c is implemented by having the control unit 21 (the processor) execute a program 23a loaded from the ROM 23 into the RAM 22. The second determination unit 21c may be implemented by hardware.

The second determination unit 21c determines one of the infrared camera image and the visible-light camera image transmitted from the control BOX 11 as the image to be displayed. For example, when the illuminance, which is the result of the detection by the illuminance sensor 60 transmitted from the control BOX 11, has decreased below a threshold (i.e., when the member of the fire brigade can no longer get an unobstructed view in the environment in which he/she works due to smoke or the like), the second determination unit 21c determines (i.e., selects) the infrared camera image as the image to be displayed. Further, when the illuminance, which is the result of the detection by the illuminance sensor 60 transmitted from the control BOX 11, has increased above a threshold (i.e., when the member of the fire brigade can get an unobstructed view in the environment in which he/she works again without being affected by smoke or the like), the second determination unit 21c determines (i.e., selects) the visible-light camera image as the image to be displayed. Regarding the threshold for this determination. For example, one stored in the ROM 23 may be used.

Next, as an example of operations performed by the video display system 1C having the above-described configuration, an image switching process 5 for switching (i.e., selecting) and displaying an infrared camera image taken by the infrared camera 10e and a visible-light camera image taken by the visible-light camera 10f will be described

The image switching process 5 is a process through which the control BOX 11 transmits the infrared camera image, the visible-light camera image, and the result of the detection by the illuminance sensor 60 to the captain terminal 20, and the captain terminal 20 determines the image to be displayed based on the result of the detection by the illuminance sensor 60 and displays only the determined image on the display 25.

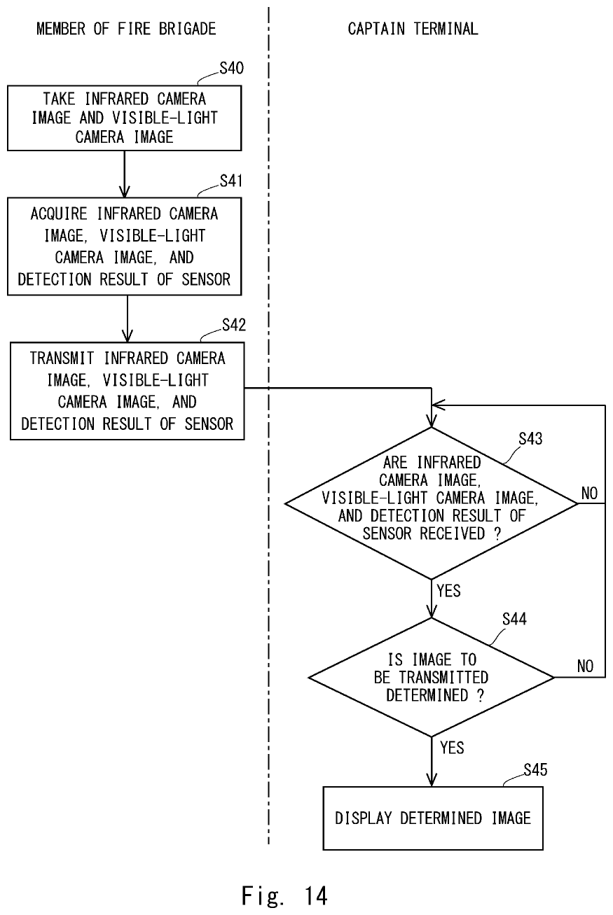

FIG. 14 is a flowchart of operations (the image switching process 5) performed by the video display system 1C.

When the control BOX 11 is powered up, the infrared camera 10e starts taking an infrared camera image, and the visible-light camera 10f starts taking a visible-light camera image (Step S40). In this process, the screen G1 (see FIG. 5) including the infrared camera image taken in the step S40 is projected onto the combiner 10d1, is reflected (and enlarged) by the combiner 10d1, and reaches the eyes of the member of the fire brigade wearing the smart mask 10. As a result, the member of the fire brigade wearing the smart mask 10 can visually recognize the infrared camera image taken in the step S40 as an enlarged virtual image as if it is floating in front of (e.g., 1.5 m in front of) the member of the fire brigade.

Next, the control BOX 11 (the first communication unit 11d) transmits the infrared camera image taken by the infrared camera 10e, the visible-light camera image taken by the visible-light camera 10f, and the result of the detection by the illuminance sensor 60 to the captain terminal 20. Specifically, firstly, the control BOX 11 (the image acquisition unit 11a1) acquires the infrared camera image from the infrared camera 10e and acquires the visible-light camera image from the visible-light camera 10f (Step S41). Further, the control BOX 11 (the second control unit 11a) acquires the result of the detection by the illuminance sensor 60 (i.e., the illuminance) from the illuminance sensor 60.

Next, the control BOX 11 (the communication control unit 11a2) wirelessly transmits the infrared camera image (video data), the visible-light camera image (video data), and the result of the detection by the illuminance sensor 60 acquired in the step S41 to the captain terminal 20 by controlling the first communication unit 11d (Step S42).

Next, when the captain terminal 20 (the second communication unit 26) receives the images (the infrared camera image and the visible-light camera image) transmitted from the control BOX 11, and the result of the detection by the illuminance sensor 60 (Step S43: Yes), the captain terminal 20 (the second determination unit 21c) determines (i.e., selects) one of the received infrared camera image and the visible-light camera image as the image to be displayed based on the result of the detection by the illuminance sensor 60 (Step S44). For example, when the illuminance, which is the result of the detection by the illuminance sensor 60, has decreased below a threshold (i.e., when the member of the fire brigade can no longer get an unobstructed view in the environment in which he/she works due to smoke or the like), the second determination unit 21c determines (i.e., selects) the infrared camera image as the image to be displayed. On the other hand, when the illuminance, which is the result of the detection by the illuminance sensor 60, has increased above a threshold (i.e., when the member of the fire brigade can get an unobstructed view in the environment in which he/she works again without being affected by smoke or the like), the second determination unit 21c determines (i.e., selects) the visible-light camera image as the image to be displayed. Regarding the threshold for this determination. For example, one stored in the ROM 11c may be used.

Here, it is assumed that the illuminance, which is the result of the detection by the illuminance sensor 60, has decreased below the threshold and hence the infrared camera image has been determined as the image to be displayed in the step S44.

In this case, the captain terminal 20 (the display control unit 21a) displays the image determined in the step S44 (in this example, the infrared camera image) on the display 25 (e.g., in corresponding one of the camera image display areas b shown in FIG. 6) (Step S45).

In this way, the leader of the fire brigade can view the infrared camera image, which is automatically displayed without having to switch the screen by himself/herself, and therefore can check the environment in which the members of the fire brigade can no longer get an unobstructed view due to smoke or like are working.

On the other hand, when the illuminance, which is the result of the detection by the illuminance sensor 60, has increased above the threshold and hence the visible-light camera image has been determined as the image to be displayed in the step S44, the captain terminal 20 (the display control unit 21a) displays the image determined in the step S44 (in this example, the visible-light camera image) on the display 25 (e.g., in corresponding one of the camera image display areas b shown in FIG. 6) (Step S45).

In this way, the leader of the fire brigade can view the infrared camera image, which is automatically displayed without having to switch the screen by himself/herself, and therefore can check the environment in which the members of the fire brigade can get an unobstructed view again without being affected by smoke or the like.

According to the fifth example embodiment, it is possible to appropriately switch (i.e., select) and display the infrared camera image or the visible-light camera image taken by the infrared camera 10e or the visible-light camera 10f provided in the smart mask 10, which is a mask worn by the member of the fire brigade, based on the result of the detection by the illuminance sensor 60.

### Sixth Example Embodiment

A video display system 1D according to a sixth example embodiment of the present invention will be described hereinafter.

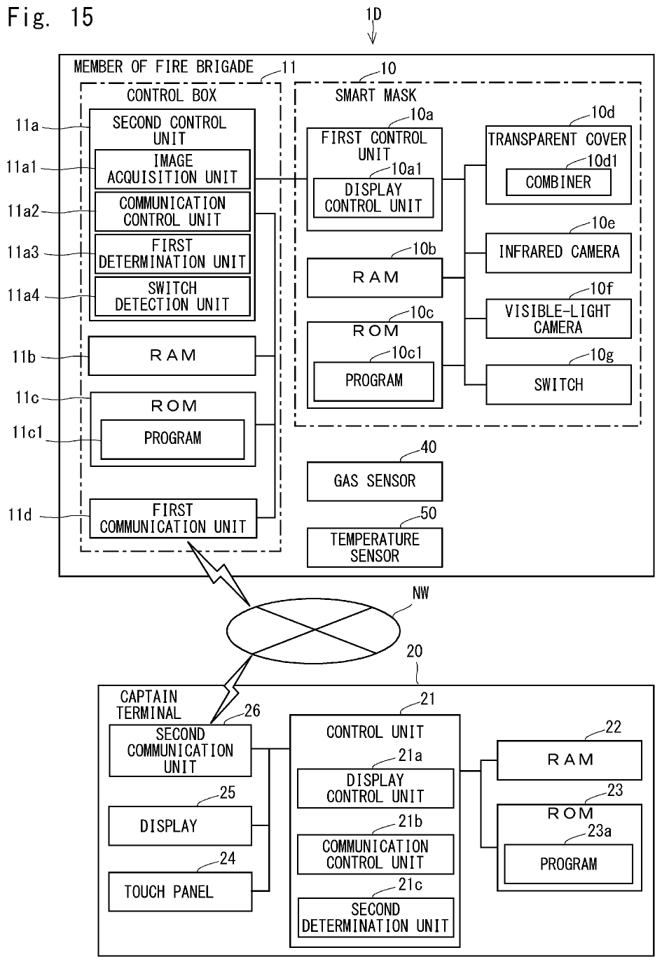

FIG. 15 is a detailed configuration diagram of the video display system 1D. The video display system 1B according to the sixth example embodiment corresponds to one that is obtained by removing the illuminance sensor 60, and adding a switch 10g and a switch detection unit 11a4 in the video display system 1C according to the fifth example embodiment shown in FIG. 13. The other components/structures are similar to those of the video display system 1A according to the third example embodiment. Since the switch 10g and the switch detection unit 11a4 have already been described above in the fourth example embodiment, descriptions thereof will be omitted.

Next, as an example of operations performed by the video display system 1D having the above-described configuration, an image switching process 6 for switching (i.e., selecting) and displaying an infrared camera image taken by the infrared camera 10e and a visible-light camera image taken by the visible-light camera 10f will be described.

The image switching process 6 is a process through which the control BOX 11 transmits the infrared camera image, the visible-light camera image, and the result of the detection by the switch detection unit 11a4 to the captain terminal 20, and the captain terminal 20 determines the image to be displayed based on the result of the detection by the switch detection unit 11a4 and displays only the determined image on the display 25.

The image switching process 6 will be described hereinafter with reference to FIG. 14.

When the control BOX 11 is powered up, the infrared camera 10e starts taking an infrared camera image, and the visible-light camera 10f starts taking a visible-light camera image (Step S40). In this process, the screen G1 (see FIG. 5) including the infrared camera image taken in the step S40 is projected onto the combiner 10d1, is reflected (and enlarged) by the combiner 10d1, and reaches the eyes of the member of the fire brigade wearing the smart mask 10. As a result, the member of the fire brigade wearing the smart mask 10 can visually recognize the infrared camera image taken in the step S40 as an enlarged virtual image as if it is floating in front of (e.g., 1.5 m in front of) the member of the fire brigade.

Next, the control BOX 11 (the first communication unit 11d) transmits the infrared camera image taken by the infrared camera 10e, the visible-light camera image taken by the visible-light camera 10f, and the result of the detection by the switch detection unit 11a4 to the captain terminal 20. Specifically, firstly, the control BOX 11 (the image acquisition unit 11a1) acquires the infrared camera image from the infrared camera 10e and acquires the visible-light camera image from the visible-light camera 10f (Step S41). Further, the control BOX 11 (the second control unit 11a) acquires the result of the detection (i.e., the On/Off state of the switch 10g) by the switch detection unit 11a4 from the switch detection unit 11a4.

Next, the control BOX 11 (the communication control unit 11a2) wirelessly transmits the infrared camera image (video data), the visible-light camera image (video data), and the result of the detection by the switch detection unit 11a4 acquired in the step S41 to the captain terminal 20 by controlling the first communication unit 11d (Step S42).

Next, when the captain terminal 20 (the second communication unit 26) receives the images (the infrared camera image and the visible-light camera image) transmitted from the control BOX 11, and the result of the detection by the switch detection unit 11a4 (Step S43: Yes), the captain terminal 20 (the second determination unit 21c) determines (i.e., selects) one of the received infrared camera image and the visible-light camera image as the image to be displayed based on the result of the detection by the switch detection unit 11a4 (Step S44). For example, when the result of the detection by the switch detection unit 11a4 indicates that the switch 10g is an On state (e.g., when the member of the fire brigade is caught in smoke and has difficulty in breathing), the second determination unit 21c determines the infrared camera image as the image to be displayed.

Next, the captain terminal 20 (the display control unit 21a) displays the image determined in the step S44 (in this example, the infrared camera image) on the display 25 (e.g., in corresponding one of the camera image display areas b shown in FIG. 6) (Step S45). In this way, the leader of the fire brigade can view the infrared camera image, which is automatically displayed without having to switch the screen by himself/herself, and therefore can check the environment in which the members of the fire brigade can no longer get an unobstructed view due to smoke or like are working.

Next, a modified example will be described.

Although an example in which the subordinate is a member of a fire brigade has been described in each of the above-described example embodiments, the subordinate or the like is not limited to this example. For example, the person wearing the smart mask 10 (and the breathing apparatus) may be, for example, a person working in an air-contaminated and hazardous environment such as a police officer, a member of the Self-Defense Forces, and a worker in a nuclear facility. The same applies to the leader.

Further, although an example in which the screen viewed by the member of the fire brigade wearing the smart mask 10 is a virtual image that is displayed, by the combiner 10d1, as if it is floating in front of the member of the fire brigade has been described in the above-described second example embodiment, the screen is not limited to this example. For example, although it is not shown, the screen (i.e., the window or the image) viewed by the member of the fire brigade wearing the mask 9 may be a screen viewed as (i.e., shown as) a real image. For example, the screen may be a screen displayed on a small display device (e.g., an organic EL display device). The small display device is attached, for example, to the smart mask 10. The small display device is disposed in front of the face of the member of the fire brigade (between the face and the transparent cover 10d) in the state in which the smart mask 10 is worn by the member of the fire brigade. Even in this configuration, the member of the fire brigade can view various screens (real images) displayed on the small display device without widely (or substantially) moving his/her line of sight.

According to the sixth example embodiment, it is possible to appropriately switch (i.e., select) and display the infrared camera image or the visible-light camera image taken by the infrared camera 10e or the visible-light camera 10f provided in the smart mask 10, which is a mask worn by the member of the fire brigade, based on the result of the detection by the switch detection unit 11a4.

In the above-described first and second example embodiments, the program may be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), CD-R, CD-R/W, and a semiconductor memory (such as a mask ROM, a PROM (Programmable ROM), an EPROM (Erasable PROM), a flash ROM, and a RAM (Random Access Memory)). Further, the programs may be supplied to computers by using various types of transitory computer readable media. Examples of the transitory computer readable media include an electrical signal, an optical signal, and an electromagnetic wave. The transitory computer readable media can be used to supply programs to a computer through a wired communication line (e.g., electric wires and optical fibers) or a wireless communication line.

All the numeral values mentioned in the above-described example embodiments are merely examples, and needless to say, numeral values different from them can be uses as desired.

The above-described example embodiments are merely examples in all the aspects thereof. The present invention should not be limited by the descriptions of the above-described example embodiments. The present invention may be carried out in various other forms without departing from the spirit or main features of the invention.

Further, the whole or part of the example embodiments disclosed above can be described as, but not limited to, the following supplementary notes.

### Supplementary note 1

A video display system comprising:

a mask configured to be worn by a subordinate who works at a site;

an infrared camera disposed on the mask;

a visible-light camera disposed on the mask;

first communication means disposed on an outfit configured to be worn by the subordinate; and

a leader terminal configured to be operated by a leader who leads the subordinate, wherein

the leader terminal comprises:

second communication means for communicating with the first communication means;

display means; and

selecting means for selecting one of an infrared camera image and a visible-light camera image as an image to be displayed, and wherein

the second communication means transmits an image acquisition request for acquiring the image selected by the selecting means to the first communication means,

when the first communication means receives the image acquisition request transmitted from the second communication means, the first communication means transmits, to the leader terminal, one of the infrared camera image and the visible-light camera image according to the image acquisition request, the infrared camera image and the visible-light camera image being images taken by the infrared camera and the visible-light camera, respectively, and

when the second communication means receives the image transmitted from the first communication means, the display means displays the received image.

### Supplementary Note 2

A video display system comprising:

a mask configured to be worn by a subordinate who works at a site;

an infrared camera disposed on the mask;

a visible-light camera disposed on the mask;

first communication means disposed on an outfit configured to be worn by the subordinate; and

a leader terminal configured to be operated by a leader who leads the subordinate, wherein

the leader terminal comprises:

second communication means for communicating with the first communication means;

display means; and

selecting means for selecting one of an infrared camera image and a visible-light camera image as an image to be displayed, and wherein

the first communication means transmits the infrared camera image and the visible-light camera image to the leader terminal, the infrared camera image and the visible-light camera image being images taken by the infrared camera and the visible-light camera, respectively,

the second communication means receives the infrared camera image and the visible-light camera image transmitted from the first communication means, and

the display means displays one of the infrared camera image and the visible-light camera image, both of which have been received by the second communication means, according to the selection by the selecting means.

### Supplementary Note 3

A video display system comprising:

a mask configured to be worn by a subordinate who works at a site;

an infrared camera disposed on the mask;

a visible-light camera disposed on the mask;

first communication means disposed on an outfit configured to be worn by the subordinate;

a leader terminal configured to be operated by a leader who leads the subordinate;

a sensor disposed on the outfit configured to be worn by the subordinate; and

first determination means disposed on the outfit configured to be worn by the subordinate, the first determination means being means for determining, based on a result of detection by the sensor, one of an infrared camera image and a visible-light camera image as an image to be transmitted to the leader terminal, wherein

the leader terminal comprises:

second communication means for communicating with the first communication means; and

display means, and wherein

the first communication means transmits, to the leader terminal, one of the infrared camera image and the visible-light camera image determined by the first determination means, the infrared camera image and the visible-light camera image being images taken by the infrared camera and the visible-light camera, respectively,

the second communication means receives the image transmitted from the first communication means, and

when the second communication means receives the image transmitted from the first communication means, the display means displays the received image.

### Supplementary Note 4

The video display system described in Supplementary note 3, wherein

the sensor is an illuminance sensor configured to detect an illuminance in an environment in which the subordinate works, and

when the illuminance, which is a result of detection by the illuminance sensor, decreases below a threshold, the first determination means determines the infrared camera image taken by the infrared camera as the image to be transmitted to the leader terminal.

### Supplementary Note 5

The video display system described in Supplementary note 3, wherein

the sensor is an illuminance sensor configured to detect an illuminance in an environment in which the subordinate works, and

when the illuminance, which is a result of detection by the illuminance sensor, increases above a threshold, the first determination means determines the visible-light camera image taken by the visible-light camera as the image to be transmitted to the leader terminal.

### Supplementary Note 6

The video display system described in Supplementary note 3, further comprising a switch disposed in the outfit configured to be worn by the subordinate and operated by the subordinate, wherein

the sensor is a sensor configured to detect an On/Off state of the switch, and

when an On state of the switch is detected as a result of detection by the sensor, the first determination means determines one of the infrared camera image taken by the infrared camera and the visible-light camera image taken by the visible-light camera as the image to be transmitted to the leader terminal.

### Supplementary Note 7

A video display system comprising:

a mask configured to be worn by a subordinate who works at a site;

an infrared camera disposed on the mask;

a visible-light camera disposed on the mask;

first communication means disposed on an outfit configured to be worn by the subordinate;

a leader terminal configured to be operated by a leader who leads the subordinate; and

a sensor disposed on the outfit configured to be worn by the subordinate, wherein

the leader terminal comprises:

second communication means for communicating with the first communication means;

display means; and

second determination means for determining, based on a result of detection by the sensor received by the second communication means, one of an infrared camera image and a visible-light camera image as an image to be displayed, and wherein

the first communication means transmits the infrared camera image, the visible-light camera image, and the result of the detection by the sensor to the leader terminal, the infrared camera image and the visible-light camera image being images taken by the infrared camera and the visible-light camera, respectively,

the second communication means receives the infrared camera image, the visible-light camera image, and the result of the detection by the sensor transmitted from the first communication means, and

the display means displays the one of the infrared camera image and the visible-light camera image determined as the image to be displayed by the second communication means, received by the second communication means.

### Supplementary Note 8

The video display system described in Supplementary note 7, wherein

the sensor is an illuminance sensor configured to detect an illuminance in an environment in which the subordinate works, and

when the illuminance, which is a result of detection by the illuminance sensor, decreases below a threshold, the second determination means determines the infrared camera image taken by the infrared camera as the image to be displayed.

### Supplementary Note 9

The video display system described in Supplementary note 7, wherein

the sensor is an illuminance sensor configured to detect an illuminance in an environment in which the subordinate works, and

when the illuminance, which is a result of detection by the illuminance sensor, increases above a threshold, the second determination means determines the visible-light camera image taken by the visible-light camera as the image to be displayed.

### Supplementary Note 10

The video display system described in Supplementary note 7, further comprising a switch disposed in the outfit configured to be worn by the subordinate and operated by the subordinate, wherein

the sensor is a sensor configured to detect an On/Off state of the switch, and

when an On state of the switch is detected as a result of detection by the sensor, the second determination means determines one of the infrared camera image taken by the infrared camera and the visible-light camera image taken by the visible-light camera as the image to be displayed.

### Supplementary Note 11

The video display system described in Supplementary note 1, wherein

the mask includes a first mask configured to be worn by a first subordinate who works at the site, and a second mask configured to be worn by a second subordinate who works at the site,

the infrared camera includes a first infrared camera disposed in the first mask, and a second infrared camera disposed in the second mask,

the visible-light camera includes a first visible-light camera disposed in the first mask, and a second visible-light camera disposed in the second mask,

the first communication means is disposed each of a first outfit configured to be worn by the first subordinate, and a second outfit configured to be worn by the second subordinate, and

when the second communication means receives an image transmitted from each of the first communication means disposed in the first outfit or the first communication means disposed in the second outfit, the display means displays the received images.

### Supplementary Note 12

The video display system described in Supplementary note 2, wherein

the mask includes a first mask configured to be worn by a first subordinate who works at the site, and a second mask configured to be worn by a second subordinate who works at the site,

the infrared camera includes a first infrared camera disposed in the first mask, and a second infrared camera disposed in the second mask,

the visible-light camera includes a first visible-light camera disposed in the first mask, and a second visible-light camera disposed in the second mask,

the first communication means is disposed in each of a first outfit configured to be worn by the first subordinate, and a second outfit configured to be worn by the second subordinate,

the second communication unit receives the infrared camera image and the visible-light camera image transmitted from the first communication means disposed in the first outfit and the first communication means disposed in the second outfit, and

the display means displays one of the infrared camera image and the visible-light camera image, which are received by the second communication means, selected by the selecting means.

### Supplementary Note 13

A video display method performed in a video display system,

the video display system comprising:

a mask configured to be worn by a subordinate who works at a site;

an infrared camera disposed on the mask;

a visible-light camera disposed on the mask;

first communication means disposed on an outfit configured to be worn by the subordinate; and

a leader terminal configured to be operated by a leader who leads the subordinate,

the leader terminal comprising:

second communication means for communicating with the first communication means; and

display means,

the video display method comprising:

a selecting step of selecting one of an infrared camera image and a visible-light camera image as an image to be displayed;

a first transmitting step of, by the second communication means, transmitting an image acquisition request for acquiring the image selected in the selecting step to the first communication means;

a second transmitting step of, when the first communication means receives the image acquisition request transmitted in the transmitting step, transmitting, to the leader terminal, one of the infrared camera image and the visible-light camera image according to the image acquisition request, the infrared camera image and the visible-light camera image being images taken by the infrared camera and the visible-light camera, respectively, and

a displaying step of, by the display means, when the second communication means receives the image transmitted from the first communication means, displaying the received image.

### REFERENCE SIGNS LIST

1, 1A-1D VIDEO DISPLAY SYSTEM
10 SMART MASK
10a FIRST CONTROL UNIT
10a1 DISPLAY CONTROL UNIT
10b RAM
10c ROM
10c1 PROGRAM
10d TRANSPARENT COVER
10d1 COMBINER
10e INFRARED CAMERA
10f VISIBLE-LIGHT CAMERA
10g SWITCH
11 CONTROL BOX
11a SECOND CONTROL UNIT
11a1 IMAGE ACQUISITION UNIT
11a2 COMMUNICATION CONTROL UNIT
11a3 FIRST DETERMINATION UNIT
11a4 SWITCH DETECTION UNIT
11b RAM
11c ROM
11c1 PROGRAM
11d FIRST COMMUNICATION UNIT
20 LEADER TERMINAL
21 CONTROL UNIT
21a DISPLAY CONTROL UNIT
21b COMMUNICATION CONTROL UNIT
21c SECOND DETERMINATION UNIT
22 RAM
23 ROM
23a PROGRAM
24 TOUCH PANEL
25 DISPLAY
26 SECOND COMMUNICATION UNIT
40 GAS SENSOR
50 TEMPERATURE SENSOR
60 ILLUMINANCE SENSOR
70 OUTFIT
71 FIRST COMMUNICATION MEANS
72 LEADER TERMINAL
73 SECOND COMMUNICATION MEANS
74 DISPLAY MEANS
NW COMMUNICATION LINE
G1/G2 SCREEN
a1: REMOTE SUPPORT MESSAGE DISPLAY AREA
a2: CAMERA IMAGE DISPLAY AREA
a3: DISPLAY AREA
a4: ENTRY ELAPSED TIME DISPLAY AREA
a5: DETECTION TARGET GAS CONCENTRATION DISPLAY AREA
b: CAMERA IMAGE DISPLAY AREA
b1: IMAGE SWITCHING BUTTON
b2: IDENTIFICATION INFORMATION
c: PHOTOGRAPH INFORMATION DISPLAY AREA
d: MESSAGE TRANSMISSION AREA

What is claimed is:

1. A video display system comprising:
a mask configured to be worn by a subordinate who works at a site;
an infrared camera disposed on the mask;
a visible-light camera disposed on the mask;
first communication unit disposed on an outfit configured to be worn by the subordinate; and
a leader terminal configured to be operated by a leader who leads the subordinate, wherein
the leader terminal comprises:
second communication unit configured to communicate with the first communication unit;
display unit; and
selecting unit configured to select one of an infrared camera image and a visible-light camera image as an image to be displayed, and wherein
the second communication unit transmits an image acquisition request for acquiring the image selected by the selecting unit to the first communication unit,
when the first communication unit receives the image acquisition request transmitted from the second communication unit, the first communication unit transmits, to the leader terminal, one of the infrared camera image and the visible-light camera image according to the image acquisition request, the infrared camera image and the visible-light camera image being images taken by the infrared camera and the visible-light camera, respectively, and
when the second communication unit receives the image transmitted from the first communication unit, the display means unit displays the received image.

2. A video display system comprising:
a mask configured to be worn by a subordinate who works at a site;
an infrared camera disposed on the mask;
a visible-light camera disposed on the mask;
first communication unit disposed on an outfit configured to be worn by the subordinate; and
a leader terminal configured to be operated by a leader who leads the subordinate, wherein
the leader terminal comprises:
second communication unit configured to communicate with the first communication unit;
display unit; and
selecting unit configured to select one of an infrared camera image and a visible-light camera image as an image to be displayed, and wherein
the first communication unit transmits the infrared camera image and the visible-light camera image to the leader terminal, the infrared camera image and the visible-light camera image being images taken by the infrared camera and the visible-light camera, respectively,
the second communication unit receives the infrared camera image and the visible-light camera image transmitted from the first communication unit, and
the display unit displays one of the infrared camera image and the visible-light camera image, both of which have been received by the second communication unit, according to the selection by the selecting unit.

3. A video display system comprising:
a mask configured to be worn by a subordinate who works at a site;
an infrared camera disposed on the mask;
a visible-light camera disposed on the mask;
first communication unit disposed on an outfit configured to be worn by the subordinate;
a leader terminal configured to be operated by a leader who leads the subordinate;
a sensor disposed on the outfit configured to be worn by the subordinate; and
first determination unit disposed on the outfit configured to be worn by the subordinate, the first determination unit being unit configured to determine, based on a result of detection by the sensor, one of an infrared camera image and a visible-light camera image as an image to be transmitted to the leader terminal, wherein
the leader terminal comprises:
second communication unit configured to communicate with the first communication unit; and
display unit, and wherein
the first communication unit transmits, to the leader terminal, one of the infrared camera image and the visible-light camera image determined by the first determination unit, the infrared camera image and the visible-light camera image being images taken by the infrared camera and the visible-light camera, respectively,
the second communication unit receives the image transmitted from the first communication unit, and
when the second communication unit receives the image transmitted from the first communication unit, the display unit displays the received image.

4. The video display system according to claim 3, wherein
the sensor is an illuminance sensor configured to detect an illuminance in an environment in which the subordinate works, and
when the illuminance, which is a result of detection by the illuminance sensor, decreases below a threshold, the first determination unit determines the infrared camera image taken by the infrared camera as the image to be transmitted to the leader terminal.

5. The video display system according to claim 3, wherein
the sensor is an illuminance sensor configured to detect an illuminance in an environment in which the subordinate works, and
when the illuminance, which is a result of detection by the illuminance sensor, increases above a threshold, the first determination unit determines the visible-light camera image taken by the visible-light camera as the image to be transmitted to the leader terminal.

6. The video display system according to claim 3, further comprising a switch disposed in the outfit configured to be worn by the subordinate and operated by the subordinate, wherein
the sensor is a sensor configured to detect an On/Off state of the switch, and
when an On state of the switch is detected as a result of detection by the sensor, the first determination unit determines one of the infrared camera image taken by the infrared camera and the visible-light camera image taken by the visible-light camera as the image to be transmitted to the leader terminal.

7-10. (canceled)

11. The video display system according to claim 1, wherein
the mask includes a first mask configured to be worn by a first subordinate who works at the site, and a second mask configured to be worn by a second subordinate who works at the site,
the infrared camera includes a first infrared camera disposed in the first mask, and a second infrared camera disposed in the second mask,
the visible-light camera includes a first visible-light camera disposed in the first mask, and a second visible-light camera disposed in the second mask,
the first communication unit is disposed each of a first outfit configured to be worn by the first subordinate, and a second outfit configured to be worn by the second subordinate, and
when the second communication unit receives an image transmitted from each of the first communication unit disposed in the first outfit or the first communication unit disposed in the second outfit, the display unit displays the received images.

12. The video display system according to claim 2, wherein
the mask includes a first mask configured to be worn by a first subordinate who works at the site, and a second mask configured to be worn by a second subordinate who works at the site,
the infrared camera includes a first infrared camera disposed in the first mask, and a second infrared camera disposed in the second mask,
the visible-light camera includes a first visible-light camera disposed in the first mask, and a second visible-light camera disposed in the second mask,
the first communication unit is disposed in each of a first outfit configured to be worn by the first subordinate, and a second outfit configured to be worn by the second subordinate,
the second communication unit receives the infrared camera image and the visible-light camera image transmitted from the first communication unit disposed in the first outfit and the first communication unit disposed in the second outfit, and
the display unit displays one of the infrared camera image and the visible-light camera image, which are received by the second communication unit, selected by the selecting unit.

13. (canceled)
